(19) United States
(12) Patent Application Publication
(10) Pub. No.: US 2010/0245682 A1
(43) Pub. Date: Sep. 30, 2010

(54) LIGHTING DEVICE FOR DISPLAY DEVICE, DISPLAY DEVICE AND TELEVISION RECEIVER

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/681,167

(22) PCT Filed: May 23, 2008
(86) PCT No.: PCT/JP2008/059552

§ 371 Date: Apr. 1, 2010

(30) Foreign Application Priority Data
Oct. 17, 2007 (JP) 2007-270182

(51) Int. Cl. H04N 5/66; H05B 37/02; G02F 1/13357

(52) U.S. Cl. 348/739; 315/294; 362/97.1; 362/97.2

(57) ABSTRACT

A lighting device for a display device of the present invention includes a plurality of light sources 17, a power source 170, a plurality of connecting terminals 152 and balance coils 56. The power source 170 supplies driving power to the light sources 17. The connecting terminals 152 are capable of holding the light sources 17 separately and function as driving power supply terminals for respective light sources. The balance coils 56 are arranged between the connecting terminals 152 and the power source 170. They are used for making the amount of current of the driving power supplied to each connecting terminal 152 constant.

### TECHNICAL FIELD

The present invention relates to a lighting device for a display device, a display device and a television receiver.

### BACKGROUND ART

In a display device using a non-light emitting optical component such as a liquid crystal display device, a backlight device is provided behind a display panel such as a liquid crystal display panel for illuminating the display panel (see Patent Document 1 as an example).

Patent Document 1: JP-A-2006-245005

### PROBLEM TO BE SOLVED BY THE INVENTION

The backlight device disclosed in the above Patent Document 1 has a configuration in which CCFLs can be driven in parallel. The Patent Document 1 discloses a lamp driving device that includes a plurality of cold cathode fluorescent lamps connected in parallel, the first current control section connected to the plurality of cold cathode fluorescent lamps and an inverter. The first current control section adjusts a level of power supplied so that the cold cathode fluorescent lamps can discharge. The inverter adjusts an input level of AC power supplied to the first current control section. With this configuration, in which the CCFLs are driven in parallel, a production cost of the CCFLs can be reduced and a percent defective can be minimized. However, the Patent Document 1 only discloses a configuration that the first current control section includes ballast capacitors but does not disclose a detailed configuration.

### DISCLOSURE OF THE PRESENT INVENTION

The present invention was made in view of the foregoing circumstances, and an object thereof is to provide a highly reliable lighting device for a display device in which light sources are driven in parallel with a simple configuration that contribute to a significant cost reduction and a low failure rate. Another object of the present invention is to provide a display device having such a lighting device for a display device and a television receiver having such a display device.

### MEANS FOR SOLVING THE PROBLEM

To solve the above problem, a lighting device for a display device of the present invention includes a plurality of light sources, a power source, a plurality of connecting terminals and balance coils. The power source supplies driving power to the light sources. The connecting terminals are capable of holding the light sources separately and function as driving power supply terminals for respective light sources. The balance coils are arranged between the connecting terminals and the power source. They are used for making the amount of current of the driving power supplied to each connecting terminal constant.

According to such a lighting device for a display device, the amount of current of the driving power supplied to the connecting terminals is made constant by the balance coils and thus a current that flows in each light source is constant. Because the balance coils are used as balancing components, only a small driving voltage is required. Therefore, the lighting device is very preferable for large-size display devices. Further, because the amount of current supplied to each light source is made constant by the balance coils, the light sources can be connected to a single power source in parallel. Therefore, a plurality of connecting terminals and the balance coils connected to the respective connecting terminals can be integrally mounted on the base, and the light sources can be driven with a simple configuration in which they are electrically connected to the base via a single line. As a result, a significant cost reduction is possible.

### BRIEF DESCRIPTION OF THE DRAWINGS

FIG. 1 is an exploded perspective view illustrating a general construction of a television receiver;

FIG. 2 is an exploded perspective view illustrating a general construction of a liquid crystal display device (display device);

FIG. 3 is a cross-sectional view of FIG. 2 along the line A-A;

FIG. 4 is a front view illustrating a construction of a main part of the lighting device for a display device;

FIG. 5 is a front view illustrating a construction of the main part illustrated in FIG. 4 without cold cathode tubes;

FIG. 6 is a rear view illustrating a construction of a main part of the lighting device for a display device;

FIG. 7 is a perspective view illustrating constructions of light source holding members;

FIG. 8 is an explanatory view illustrating a driving power supplying mechanism for the cold cathode tubes;

FIG. 9 is an explanatory schematic view illustrating a configuration related to power supply;

FIG. 10 is a perspective view illustrating a construction of a clip terminal;

FIG. 11 is a perspective view illustrating a construction of the cold cathode tube;

FIG. 12 is a plan view illustrating a construction of a ferrule connected to the cold cathode tube;

FIG. 13 is a front view illustrating a construction of the clip terminal holding the cold cathode tube;

FIG. 14 is a plan view illustrating a construction of the clip terminal holding the cold cathode tube;

FIG. 15 is a perspective view illustrating a modification of the cold cathode tube;

FIG. 16 is a perspective view illustrating a modification of the ferrule;

FIG. 17 is a perspective view illustrating a modification of the clip terminal;

FIG. 18 is an explanatory view illustrating the ferrule fitted in the clip terminal;

FIG. 19 is an explanatory view illustrating a modification of the driving power supplying mechanism for the cold cathode tubes;

FIG. 20 is an explanatory view illustrating a modification of the driving power supplying mechanism for the cold cathode tubes;

FIG. 21 is an explanatory view illustrating an example of a mechanism that provides insulation between a chassis and the clip terminals;

FIG. 22 is an explanatory view illustrating an example of a mechanism that provides insulation between a chassis and the clip terminals;

FIG. 23 is an explanatory view illustrating a driving power supplying mechanism having a detection circuit;

FIG. 24 is a rear view illustrating a construction of a lighting device for a display device;

FIG. 25 is a rear view illustrating a construction of a modification of the lighting device for a display device;

FIG. 26 is a rear view illustrating a construction of a modification of the lighting device for a display device; and

FIG. 27 is a rear view illustrating a construction of a modification of the lighting device for a display device.

### BEST MODE FOR CARRYING OUT THE INVENTION

An embodiment of the present invention will be explained with reference to drawings.

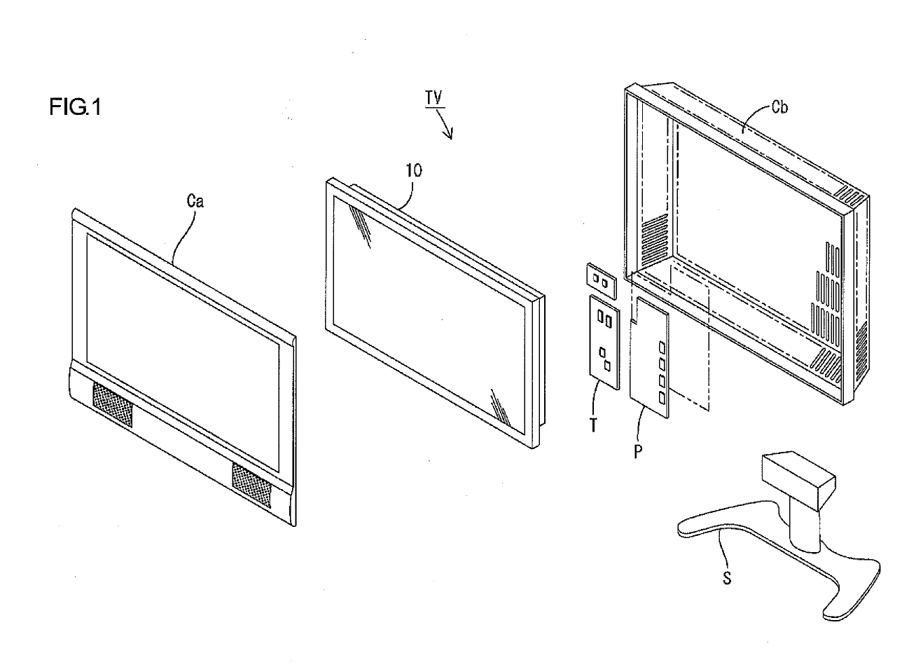

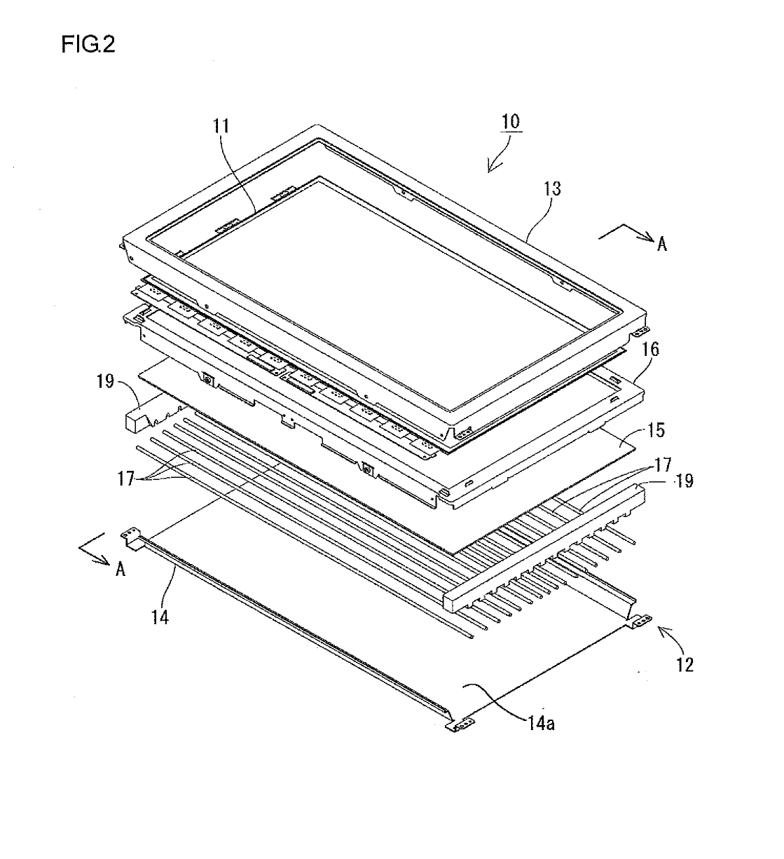

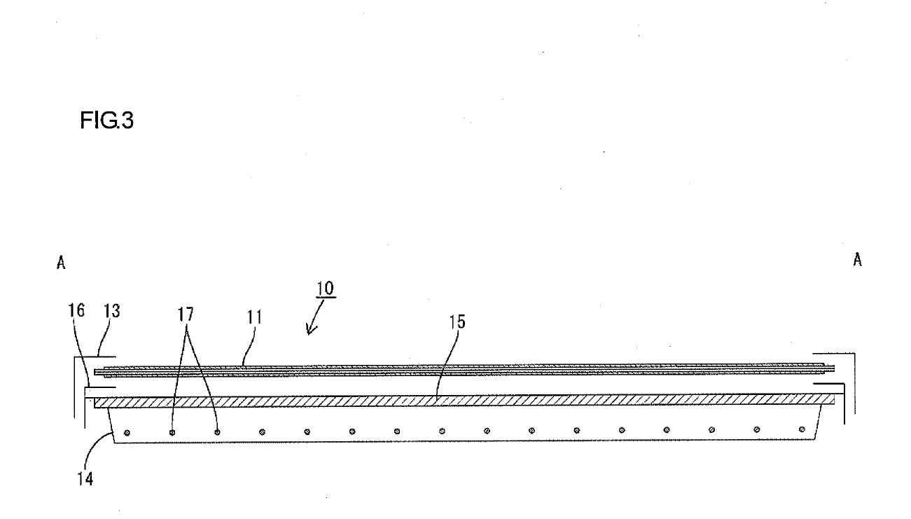

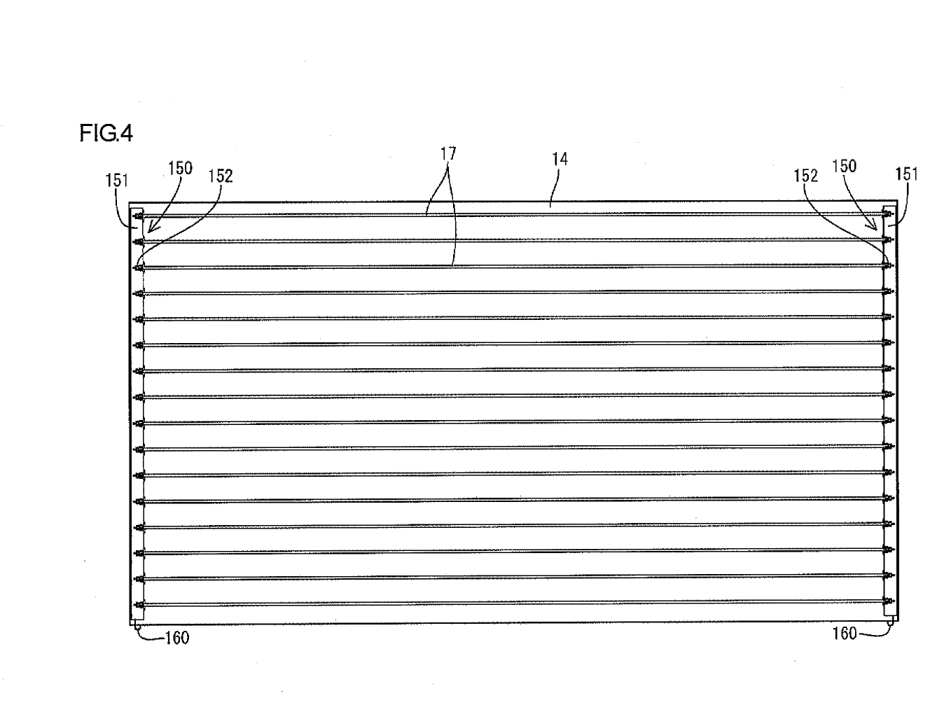

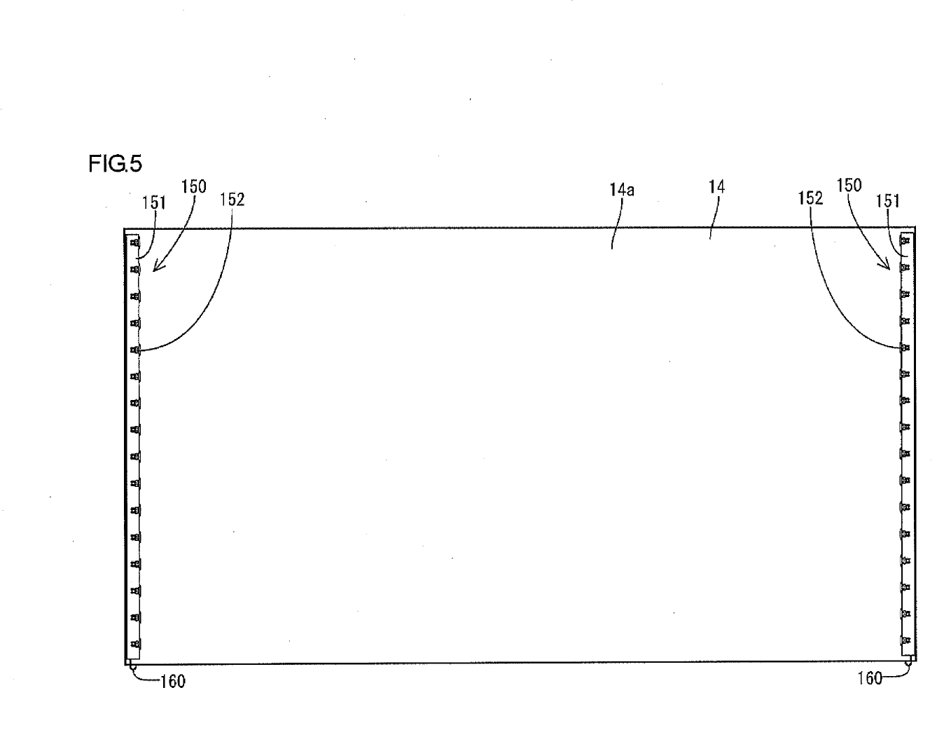

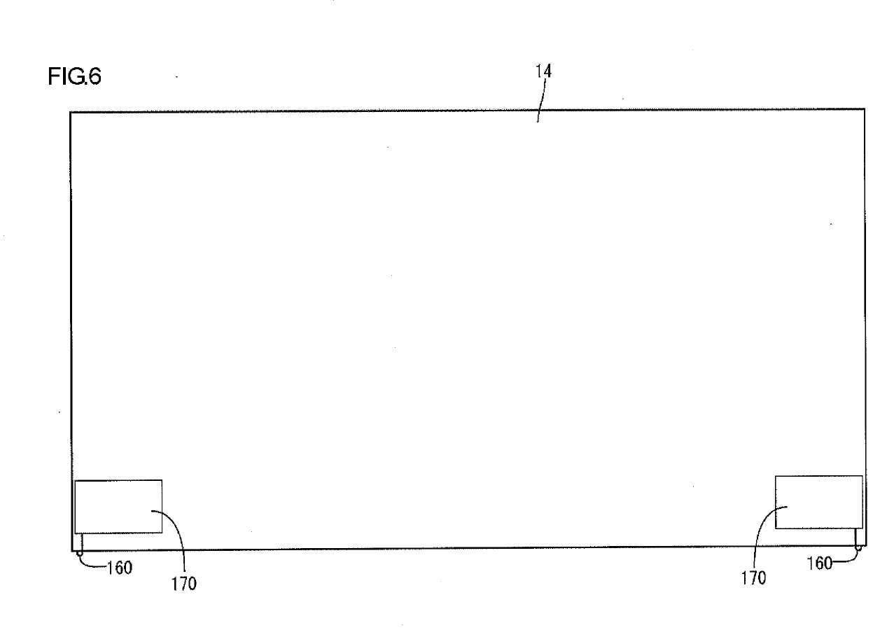

FIG. 1 is an exploded perspective view illustrating a general construction of a television receiver. FIG. 2 is an exploded perspective view illustrating a general construction of a liquid crystal display device (display device) 10. FIG. 3 is a cross-sectional view of FIG. 2 along the line A-A. FIG. 4 is a front view illustrating a construction of a main part of a backlight device included in the liquid crystal display device 10. FIG. 5 is a front view illustrating a construction of the main part of the backlight device. FIG. 6 is a rearview illustrating a construction of the main part of the backlight device.

As illustrated in FIG. 1, the television receiver TV of the present embodiment includes a liquid crystal display device (display device) 10, front and rear cabinets Ca, Cb that house the liquid crystal display device 10 therebetween, a power source P, a tuner T and a stand S. An overall view of the liquid crystal display device 10 is a landscape rectangular. As illustrated in FIG. 2, it includes a liquid crystal panel 11, which is a display panel having a rectangular plan view, and a backlight device (lighting device for a display device) 12, which is an external light source. They are integrally held by a bezel 13 and the like.

The liquid crystal panel 11 has a known configuration such that liquid crystal (a liquid crystal layer) that changes its characteristics according to applied voltages is sealed between a transparent TFT substrate and a transparent CF substrate. A number of source lines and gate lines are formed on an inner surface of the TFT substrate. The source lines extend in a longitudinal direction and the gate lines extend a transverse direction so as to form a grid pattern. Color filters including red (R), green (G) and blue (B) are provided on the CF substrate. Polarizing plates are attached to surfaces of those substrates on sides opposite from the liquid crystal side.

The backlight device 12 is a so-called direct backlight device in which a light source is arranged closely below the liquid crystal panel 11. The backlight device 12 includes a chassis 14, a reflective sheet 14a, an optical member 15, a frame 16, cold cathode tubes 17 and lamp holders 19. The chassis 14 has an opening on the front (light emitting side). The reflective sheet 14a is placed inside the chassis 14. The optical members 15 are arranged around the opening of the chassis 14. The frame 16 holds the optical member 15. The cold cathode tubes 17 are installed in the chassis 14. The lamp holders 19 position and fix the cold cathode tubes 17 to the chassis 14.

The optical member 15 has a function that converts linear light emitted from each cold cathode tube 17, which is a linear light source, to planar light, and directs the planar light toward an effective display area of the liquid crystal panel 11 (directivity).

The chassis 14 is formed of metal and in a substantially box-shape having a rectangular plan view and an opening on the front (light emitting side). The reflective sheet 14a is made of synthetic resin and a white material having good reflectivity. It is disposed in the chassis 14 so as to cover an entire inner surface of the chassis 14. The reflective sheet 14a directs most light emitted from each cold cathode tube 17 toward an opening side of the chassis 14.

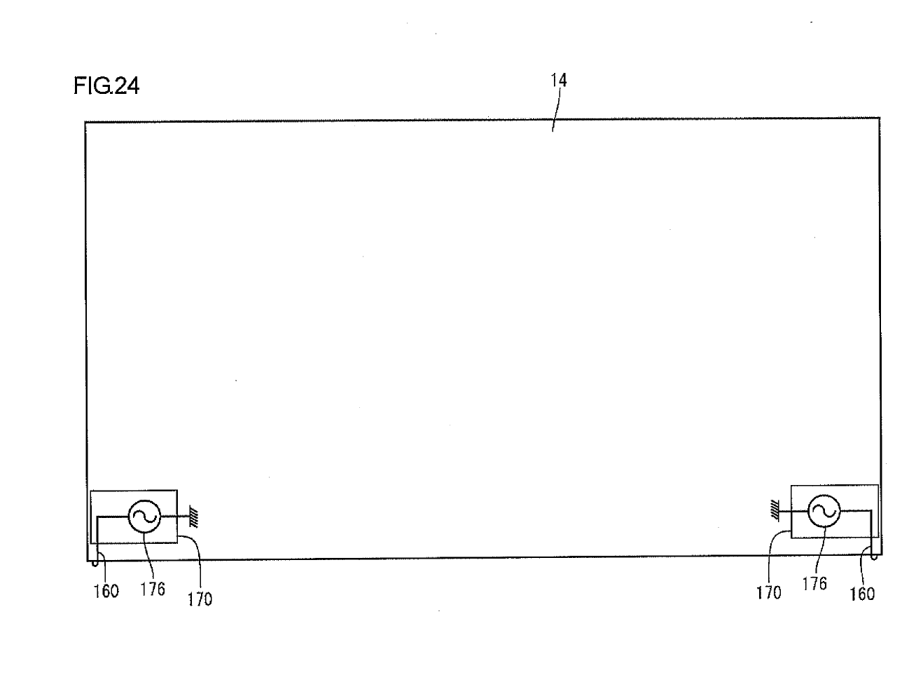

As illustrated in FIGS. 4 and 5, clip terminals (connecting terminals) 152 for holding ends of the cold cathode tubes 17 and feeding driving power to the cold cathode tubes 17 are disposed on an inner surface of the chassis 14. As illustrated in FIG. 6, power supply boards 170 including inverter circuits for supplying driving power to the cold cathode tubes are disposed on the rear surface of the chassis 14. Configuration and operation for supplying the driving power to the cold cathode tubes 17 will be explained. A two-side driving system is used here. As illustrated in FIG. 24, power sources 176 are included in the power supply boards 170 arranged on either side and supply power to the cold cathode tubes 17 via their both ends.

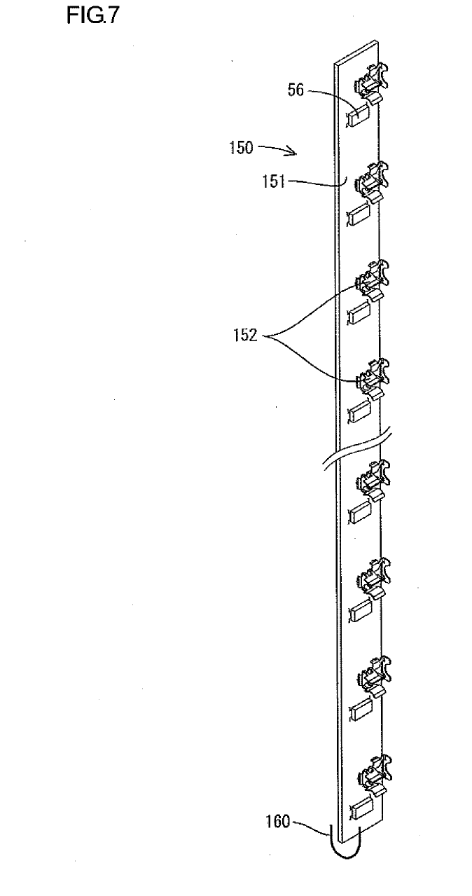

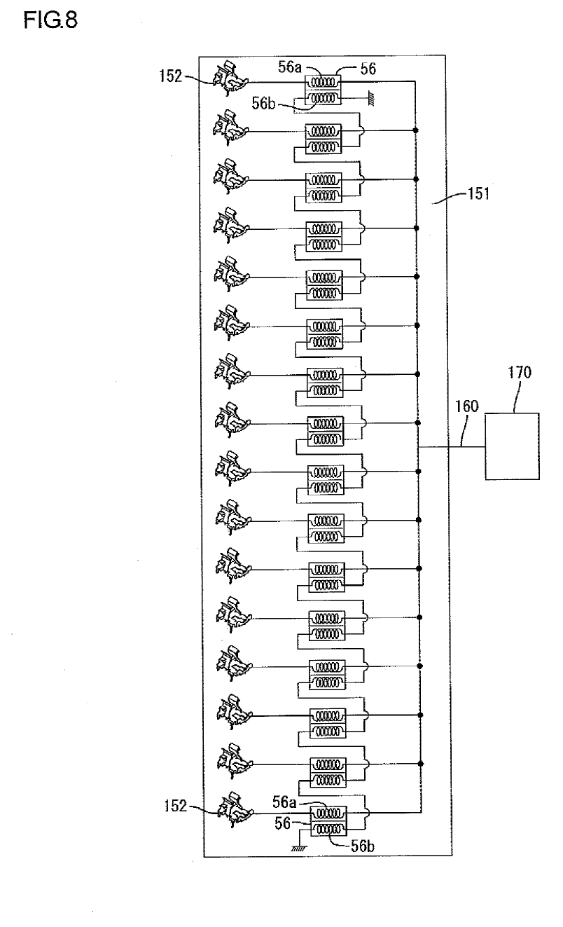

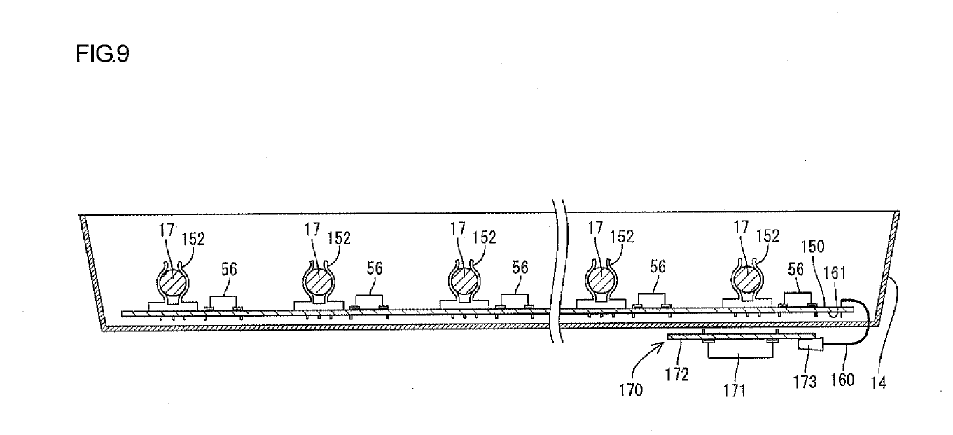

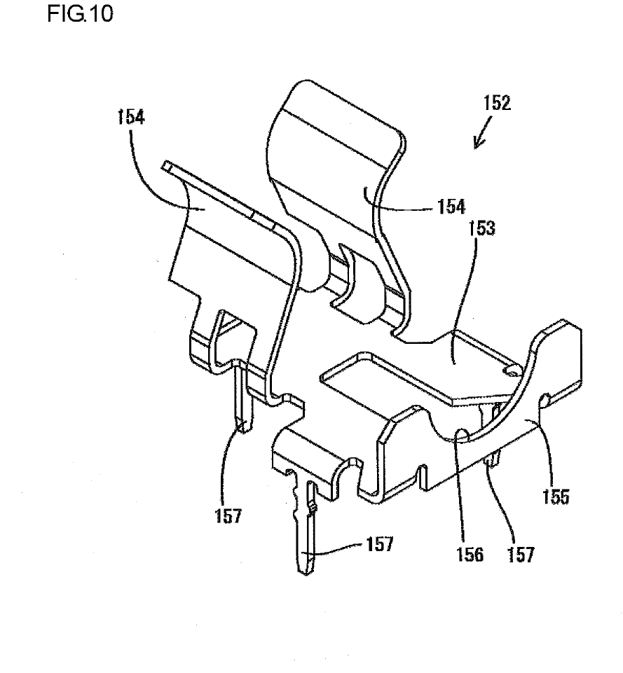

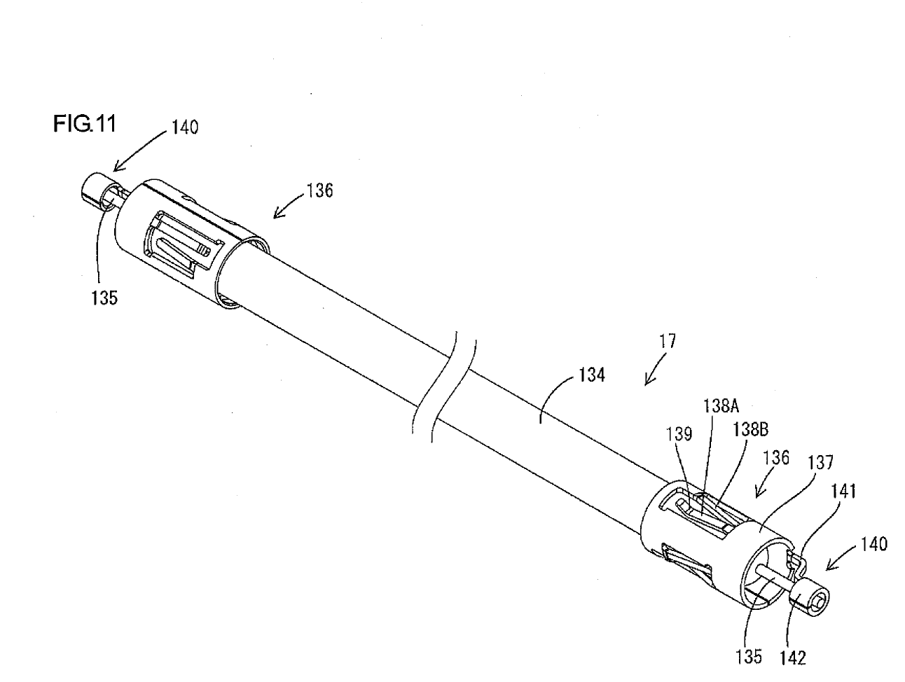

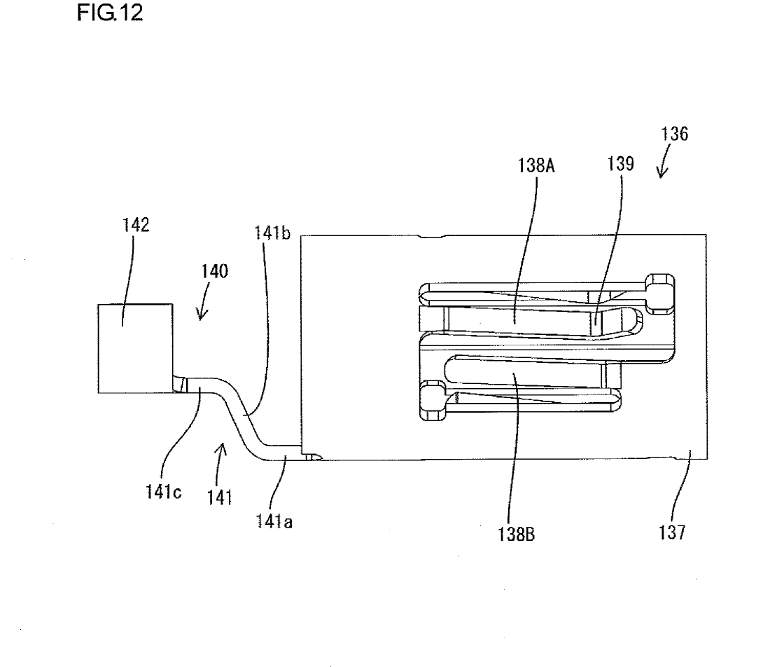

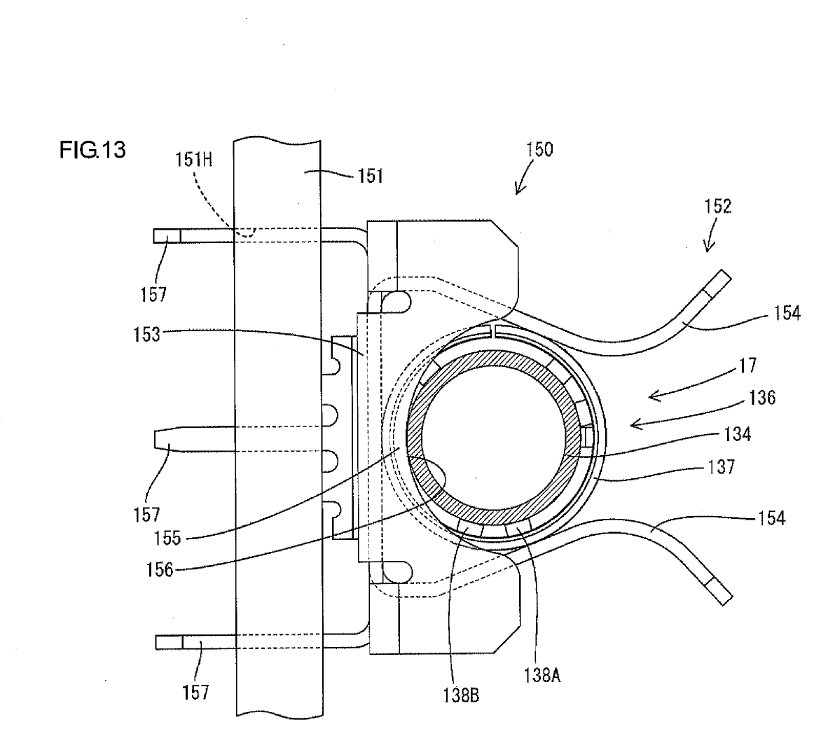

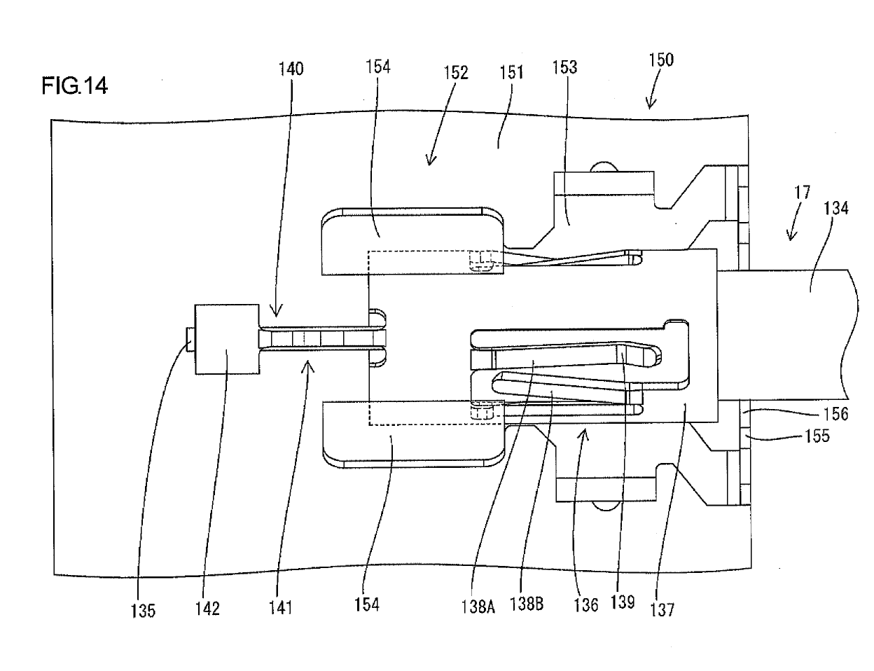

FIG. 7 is a perspective view illustrating a general construction of light source holding members (base) 150 including the clip terminals 152. FIG. 8 is an explanatory view illustrating a circuit configuration related to power supply. FIG. 9 is an explanatory schematic view related to the power supply. FIG. 10 is a perspective view illustrating a construction of the clip terminal 152. FIG. 11 is a perspective view illustrating a construction of the cold cathode tube 17. FIG. 12 is a plan view illustrating a construction of the ferrule 136 connected to the cold cathode tube 17. FIG. 13 is a front view illustrating a construction of the clip terminal 152 holding the cold cathode tube 17. FIG. 14 is a plan view illustrating a construction of the clip terminal 152 holding the cold cathode tube 17.

[Cold Cathode Tubes 17]

First, the construction of each cold cathode tube 17 will be explained.

As illustrated in FIG. 11, the cold cathode tube 17 is constructed of a glass tube 134, outer leads 135 and ferrules 136. The glass tube 134 is a linear glass tube having a longitudinal overall shape and a circular cross section. The outer leads 135 are made of metal (e.g., nickel or cobalt containing metal) and formed in a longitudinal shape having a circular cross section with the same center as the glass tube 134. They extend linearly. The ferrules 136 are mounted to the respective ends of the glass tube 134. Mercury is sealed inside the glass tube 134. The ends of the glass tube 134 are heated and melted so as to form a substantially dome shape. The outer leads 135 penetrate through the domes.

As illustrated in FIG. 12, each ferrule 136 is a single part formed in that shape by bending or hammering a metal plate (e.g., a stainless plate) punched out in a predetermined shape. The ferrule 136 includes one body 137 and a pair of conductive pieces 140. The body 137 has a cylindrical overall shape with the same center as the glass tube 134. An inner diameter of the body 137 is defined slightly larger than an outer diameter of the glass tube 134.

The body 137 has three pairs of elastic holding pieces 138A, 138B formed at an equal angle pitch in a circumferential direction by cutting parts of the body 137 in slits.

The first elastic holding piece 138A among a pair of the elastic holding pieces 138A, 138B has a cantilever-like shape that extends generally toward the rear (specifically, toward an inner direction slightly diagonal to the radial direction). It is elastically flexible in the radial direction with its base portion (front end) as a pivot point. An extending end (rear end) of the first elastic holding piece 138A has a bending portion 139 where the piece is bent at an angle outward in a radial direction. A surface of the bending portion 139 on a crest side (i.e., a surface facing inward) is a contact point that will come in contact with a periphery of the glass tube 134. An imaginary circle that connects the contact points of three of the first elastic holding pieces 138A has the same center as the body 137. A diameter of the imaginary circle is smaller than the outer diameter of the glass tube 134 when the first elastic holding pieces 138A are in a free state without any elastic deflection.

The second elastic holding piece 138B among a pair of the elastic holding pieces 138A, 138B is provided adjacent to the first elastic holding piece 138A in the circumferential direction. It has a cantilever-like shape that extends generally toward the front (specifically, toward an inner direction slightly diagonal to the radial direction), which is an apposite direction from the extending direction of the first elastic holding piece 138A. It is elastically flexible in the radial direction with its base portion (rear end) as a pivot point. An extending end of the second elastic holding piece 138B is a contact point that will come into contact with a periphery of the glass tube 134. An imaginary circle that connects the contact points of three of the second elastic holding pieces 138B has the same center as the body 137. A diameter of the imaginary circle is smaller than the outer diameter of the glass tube 134 when the second elastic holding pieces 138B are in a free state without any elastic deflection.

The body 137 has cantilever-like conductive pieces 140 that extend from ends of the body 137 forward. Each conductive piece 140 has a stem portion 141 that continues from the front end of the body 137 and a drum-shaped portion 142 that extends from a front end (extending end) of the stem portion 141 further forward. The stem portion 141 has a base section 141a, a middle section 141b and an end section 141c. The base section 141a extends from the body 137 along an axis of the body 137 such that the surfaces thereof and the body 137 are on the same flat plane. The middle section 141b extends from an extending end of the base section 141a toward the axis of the body 137, that is, inward in the radial direction of the body 137. The end section 141c extends along the axis of the body 137. The drum-shaped portion 142 is connected with the extending end of the end section 141c. A width of the stem portion 141 is sufficiently smaller than a length of the stem portion 141. This allows the stem portion 141 to elastically deform in the radial direction of the body 137 and in a direction that crosses the radial direction (a direction that crosses the longitudinal direction of the stem portion 141). It also allows the stem portion 141 to twist around an axis, which is the stem portion 141 itself. The drum-shaped portion 142 is formed in a drum-like shape by bending a portion that extends from the extending end of the stem portion 141 in the lateral direction so as to have an axis substantially in the same position as the axis of the body 137. The drum-shaped portion 142 can be displaced in a helical direction and a radial direction of the ferrule 136 with elastic flexibility of the stem portion 141.

[Light Source Holding Member 150]

Next, a construction of the light source holding members 150 will be explained.

Each light source holding member 150 has a function for holding the ends of the cold cathode tube 17 and mounting the cold cathode tube 17 to the chassis 14. It also functions as a terminal for supplying electrical power to the cold cathode tube 17.

As illustrated in FIGS. 4 and 5, the light holding members 150 are mounted to both sides of the chassis 14. Each of them includes an elongated base (supporting plate) 151, a plurality of clip terminals 152 mounted on the front surface of the base 151, and balance coils 56 for outputting a constant electrical current for the driving power supplied to each clip terminal 152. The base 151 has three mounting through holes for each clip terminal 152. The base 151 is made of conductive material such as metal.

As illustrated in FIG. 10, each clip terminal 152 is formed by bending a metal plate (e.g., nickel silver alloy) punched in a predetermined shape. It has a base 153, a pair of elastically pressing pieces 154 and a stopper 155. Each of the elastically pressing pieces 154 extends from an upper edge or a lower edge of the base 153 toward the front. They are formed vertically symmetric.

The elastically pressing pieces 154 are formed in an opposite end area from the stopper 155 and in a form that curves toward each other. The elastically pressing pieces 154 may be elastically deflected such that a gap between them is widened. The minimum gap between the pair of elastically pressing pieces 154 is smaller than the outer diameter of the glass tube of the cold cathode tube 17 when the elastically pressing pieces 154 are in a state without any elastic deflection.

The stopper 155 extends from the base 153 so as to stand at right with respect to the axis of the cold cathode tube 17. A part of a side of the stopper 155 is cut in a substantially semi-circular shape and a blank 156 is formed. Upper and lower portions of the stopper 155 around the blank 156 extending from the base 153 are small and thus the amount of metal material required for the clip terminal is small.

Furthermore, three legs 157 are formed integrally with the base 153. Two of them are located between the elastically pressing pieces 154 and the stopper 155, and extend from the upper and lower edges of the base 153 toward an opposite side (rear side) from the elastically pressing piece 154 and the stopper 155. The other one is located at an intermediate position between the elastically pressing pieces 154 in an opposite end area from the stopper 155, and extends from the base 153 toward an opposite side (rear side) from the elastically pressing piece 154 and the stopper 155.

The clip terminal 152 is not housed by a resin member and the like, and directly fixed to the base 151 by soldering and the like without any covering with the legs 157 passed through the mounting holes.

Each balance coil 56 is a balancing component and includes a primary coil 56a and a secondary coil 56b as illustrated in FIG. 8. One balance coil 56 is provided for each clip terminal 152 and integrally arranged with the clip terminal 152 on the base 151. The balance coil 56 is connected to the power supply board (power source) 170 in parallel. It is connected to a common line 161 in parallel here. Electrical connection with the power supply board (power source) is collectively made through a line 160 connected to the common line 161. The primary coils 56a are connected to the respective clip terminals 152 and the secondary coils 56b are connected with each other in series.

The balance coils 56 and the power supply board 170 are connected via lines that are less than the cold cathode tubes 17, specifically, connected via one line (power supply means) 160. The power supply line 160 is routed from an edge of the base 151 disposed on the inner surface (inner surface side) of the chassis 14 to the power supply board 170 disposed on the outer surface (outer surface side) of the chassis 14, for example, as illustrated in FIG. 9. The power supply line 160 and the balance coils 56 are electrically connected via the common line 161 disposed on the rear surface side of the base 151.

[Power Supply Board 170]

As illustrate in FIG. 9, the power supply board 170 includes a circuit board 172 having circuits on the rear surface (on the opposite side from the chassis 14), electronic components 171 mounted on the rear surface of the circuit board 172, and an on-board connector 173 mounted on the rear surface of the circuit board 172. The electronic components 171 include a transformer, and the circuit board 172 is configured as an inverter circuit board that generates a high frequency voltage. The on-board connector 173 is mounted on an edge area of the circuit board 172 and connected to the line 160. The power supply board 170 is assembled and fixed to the chassis 14 with screws and the like.

[Attaching the Cold Cathode Tube 17 to the Clip Terminals 152]

When attaching the cold cathode tube 17 to the clip terminals 152, holding it horizontally straight, bring it close to the front of the chassis 14, and push the ends of the glass tube 134 and the ferrules 136 in the gaps between the respective pairs of elastic pressing pieces 154 that face each other from the front side (see FIGS. 13 and 14). The elastically pressing pieces 154 are elastically deflected by the bodies 137 of the ferrules 136 to widen the gaps. After each body 137 has passed the minimum gap areas between the pair of elastically pressing pieces 154, the elastically pressing pieces 154 draw the body 137 toward the base 153 side with the elastic resilience thereof. As a result, the body 137 is brought into contact with the base 153 and the attachment of the cold cathode tube 17 is complete.

The attached cold cathode tube 17 is held by the clip terminals 152 at the ends thereof. The elastically pressing pieces 154 elastically contact the outer walls of the bodies 137 of the ferrules 136 and thus the outer leads 135 are connected to the clip terminals 152 via the ferrules 136 with conductivity. Further, the glass tube 134 is pressed against the stopper 155 and held in the blanks 156 by the elastic resilience of the elastically pressing pieces 154. Parts of the bodies 137 overlap the stoppers 155 when viewed in the axial direction of the cold cathode tube 17. Namely, parts of the edges of the bodies 137 on the sides opposite from the conductive pieces 40 are positioned closely to the stoppers 155 in the axial direction and face the stoppers 155.

According to the television receiver TV of the present embodiment, the liquid crystal display device 10 includes the backlight device 12 having the configuration of the present invention. Therefore, it provides the following operation effects.

Since the balance coils 56 are connected between the clip terminals 152 and the power supply board 170 to output the constant current for the driving power supplied to each clip terminal 152, the current supplied to each cold cathode tube 17 is constant. The balance coils 56 are used as balancing components. Therefore, the driving voltage is small and the lighting device is very preferable for the liquid crystal display device 10 included in the television receiver TV, which is a large-screen TV. Further, the amount of current supplied to each cold cathode tube 17 is kept at a constant level. Therefore, the cold cathode tubes 17 are connected to a single power source 170 in parallel.

As a result, a plurality of the clip terminals 152 and the balance coils 56 connected to the clip terminals 152 are provided integrally on the base 151, and electrical connection between the base 151 and the power supply board 170 is made with a single line. This simple configuration, that is, connection with a single line, allows the configuration for driving the cold cathode tubes 17 simple and can significantly reduce the cost.

The present invention is not limited to the embodiments explained in the above description. The following embodiments may be included in the technical scope of the present invention, for example.

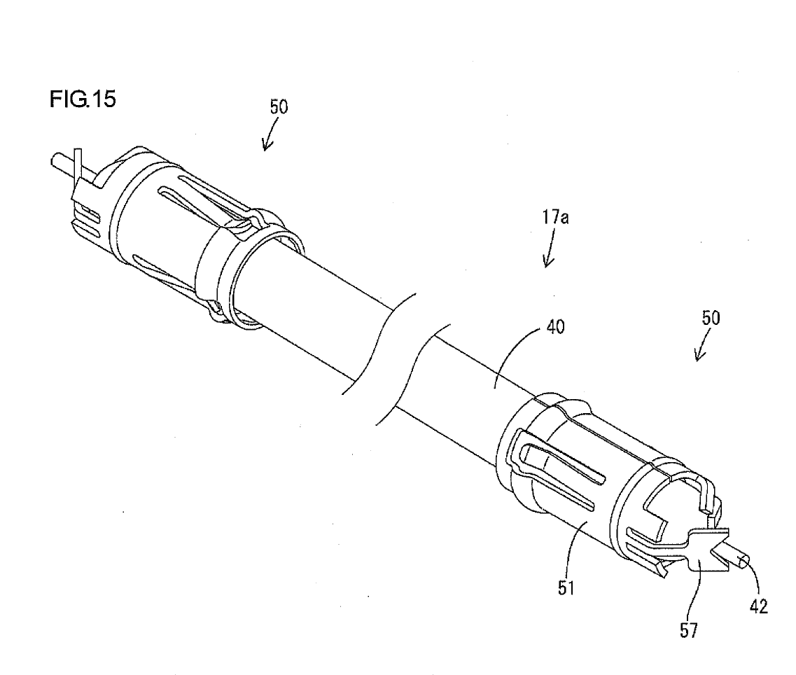

Cold cathode tubes 17a illustrated in FIG. 15 may be used instead of the cold cathode tubes 17 used in the above embodiment. Each cold cathode tube 17a includes a glass tube 40, outer leads 42 and ferrules 50. Each outer lead 42 has an elongated shape and extends from either ends of the glass tube 40 linearly and concentrically with the glass tube 40. The ferrules 50 are attached to the ends of the glass tube 40.

Each ferrule 50 is formed by bending a metal plate (e.g., copper alloy plate) punched in a predetermined shape, and includes a body 51 and a conductive piece 57. The body 51 has an overall cylindrical shape and is attached to the periphery of the glass tube 40. The conductive piece 57 extends from an edge of the body 51. It elastically contacts the periphery of the outer lead 42 and is fixed by welding. Namely, ferrules for the cold cathode tube 171a may be configured such that outer leads are electrically connected via the conductive pieces 57 instead of drum-shaped portions.

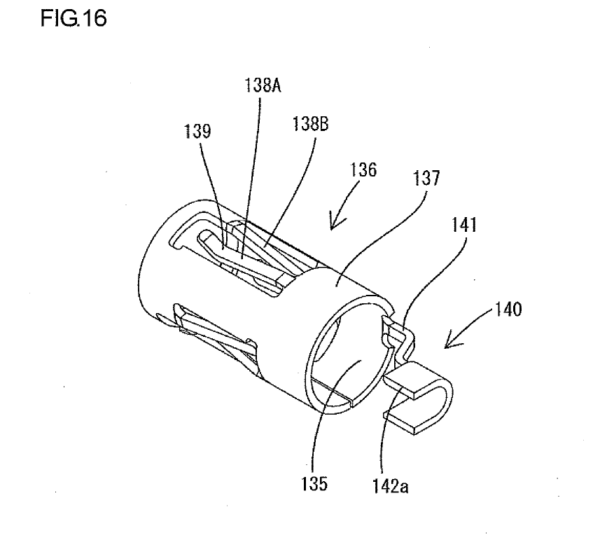

The ferrules may be configured as illustrated in FIG. 16. The drum-shaped portions 142 of the ferrules 136 illustrated in FIGS. 11 and 12 may be modified to connecting portions 142a having a U-shape. When the glass tube 134 is fitted in the ferrules 136, the U-shaped connecting portions 142a are bent along the outer leads 135 and thus the outer leads 135 can be electrically connected with the connecting portions 142a. This modification, that is, the connecting portions 142 are formed in a U-shape by bending, provides better electrical connection between the ferrules and the outer leads 135.

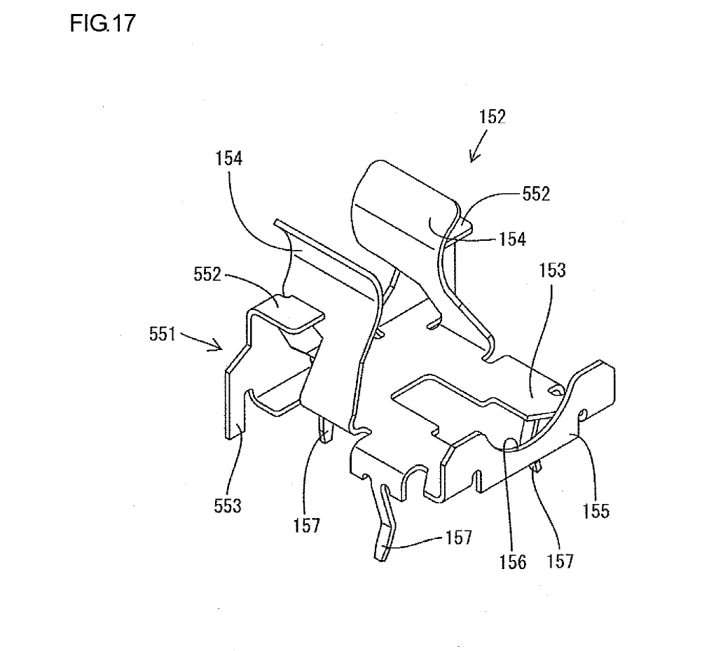

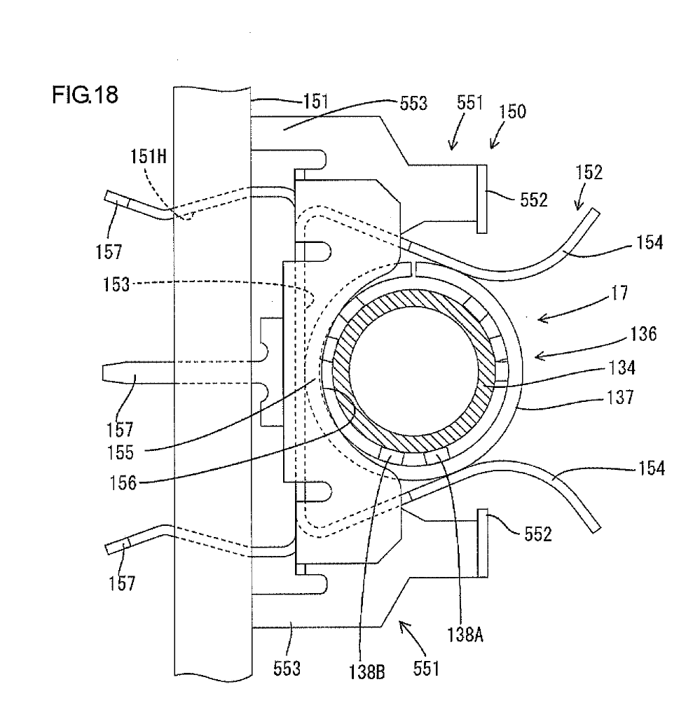

The clip terminals 152 may be configured as illustrated in FIGS. 17 and 18. Each clip terminal 152 has protecting portions (elasticity control portions) 551 for the elastically pressing pieces (elastic pieces) 154. Each protecting portion 551 includes an elastic pressing piece control section 552 and a supporting plate contact section 553. When the clip terminal 152 is mounted to the base 151 and fixed, the supporting plate contact sections 553 are brought into contact with the base 151 or close to the base 151. When an external force is applied to the elastically pressing pieces 154 and the elastically pressing pieces 154 are outstretched, they first contact the elastically pressing piece control section 552. If a larger force is applied to the elastically pressing pieces 154, the supporting plate contact sections 553 support the protecting portions 551 so that the protecting portions 551 are not bent. The protecting portions 551 continue from the bases of the elastically pressing pieces 154. To make the supporting plate contact sections 553 function properly, the supporting plate contact sections 553 should be provided lateral to the areas where the protecting portions 551 and the bases of the elastically pressing pieces 154 are connected. Providing the supporting plate contact sections 553 more lateral can enhance the effect.

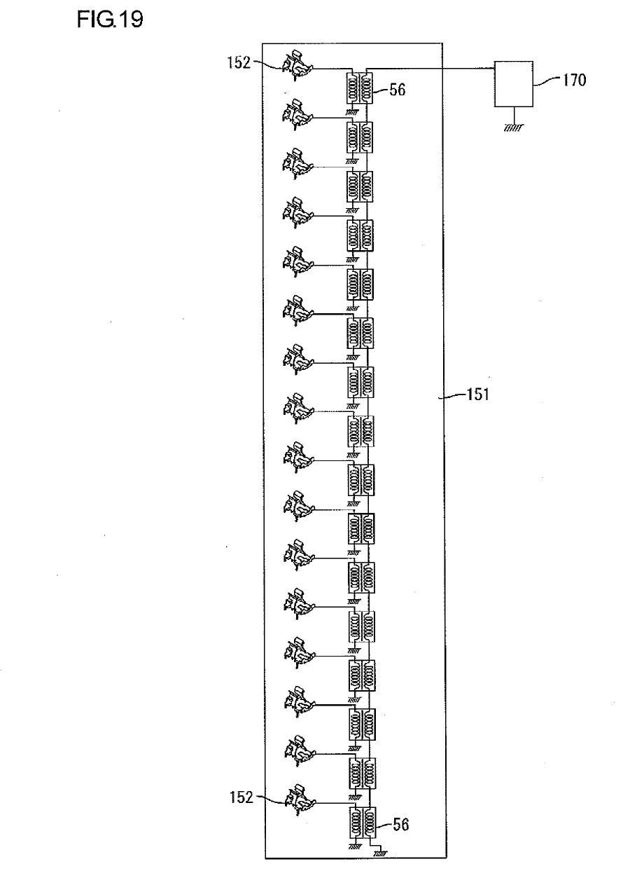

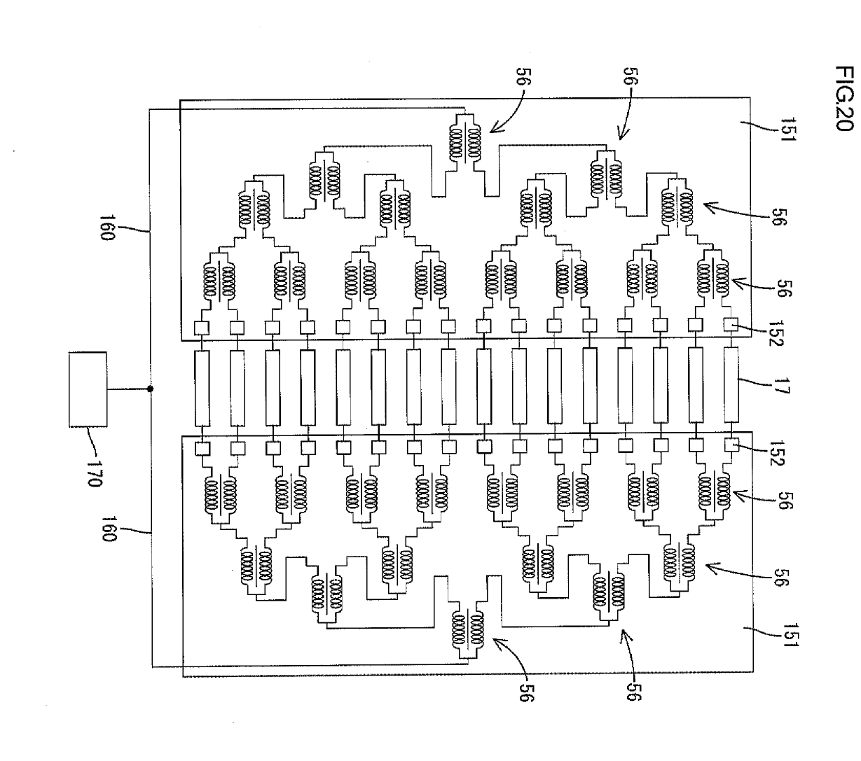

The power supply board 170, the balance coils 56 and the clip terminals 152 can be connected as illustrated in FIG. 19. The clip terminals 152 are connected to the secondary sides of the balance coils 56. The balance coils 56 are arranged such that the primary sides of the balance coils 56 are connected in series. This configuration also makes the amount of current supplied to each clip terminal 152 (i.e., each cold cathode tube 17) constant. It also allows the connection between the power supply board 170 and the base 151 that collectively includes the clip terminals 152 and the balance coils 56 with a single line. The balance coils 56 may be arranged in a tree structure as illustrated in FIG. 20. In FIG. 20, sixteen cold cathode tubes 17 are provided and fifteen balance coils 56 are disposed on one side each. This configuration also makes the amount of current supplied to each clip terminal 152 (i.e., each cold cathode tube 17) constant. It also allows the connection between the power supply board 170 and the base 151 that collectively includes the clip terminals 152 and the balance coils 56 with a single line.

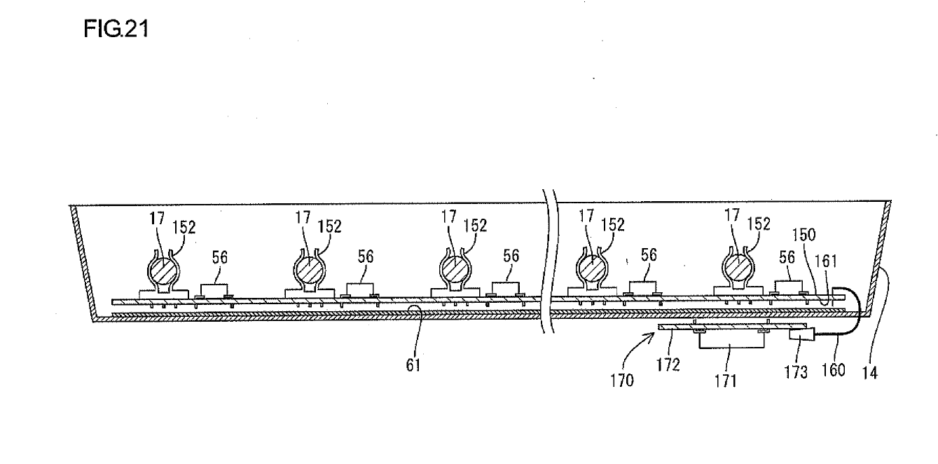

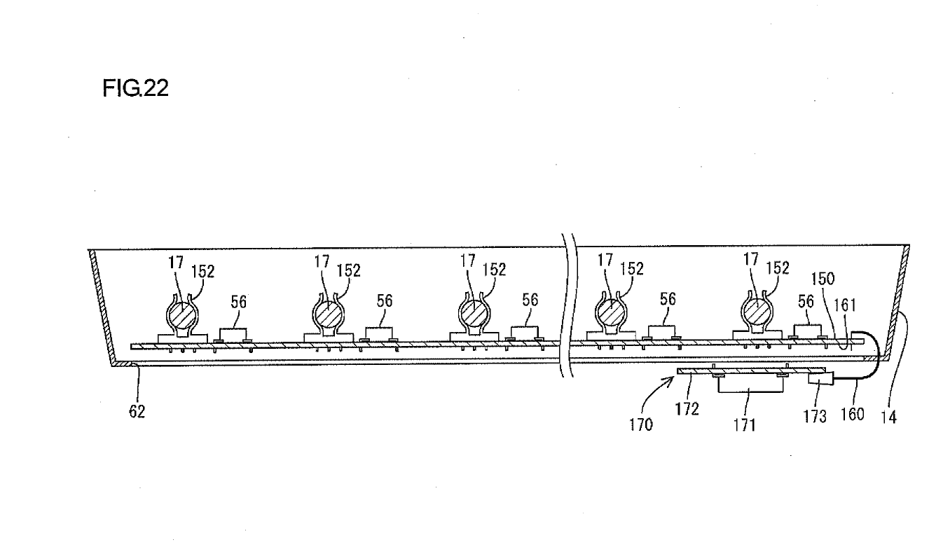

To obtain insulation between the chassis 14 and the base 151, an insulation plate (insulation member) 61 may be provided between the chassis 14 and the base 151 as illustrated in FIG. 21. As illustrated in FIG. 22, an opening 62 may be provided in an area of the chassis 14 that overlaps the base 151. Alternatively, the chassis 14 may be made of resin material.

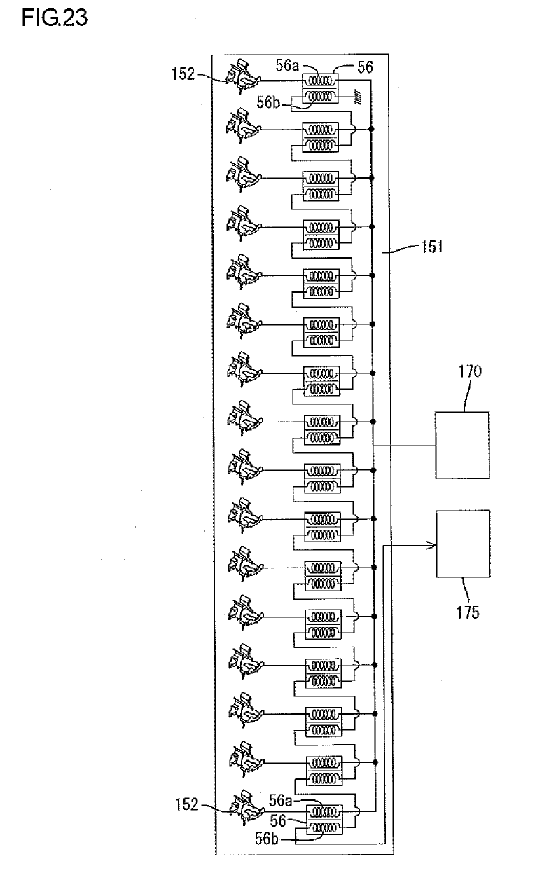

A detection circuit 175 illustrated in FIG. 23 may be provided as an open circuit detection circuit. The detection circuit 175 includes a fail-safe circuit that disable the operation when an unlit cold cathode tube 17 is detected, that is, the circuit is open. It sends feedback indicating an output current of the balance coil 56b on the secondary side. In FIG. 23, the detection circuit 175 detects a current drawn out from a loop circuit on the secondary side of the balance coils 56 off the substrate 151. The detected current is fed back to the power supply board 170 and if an input voltage continues to rise in a condition that the detected current is very small, an open circuit is determined. Then, the supply of the driving power is stopped. In this embodiment, the balance coils 56 are used as balancing components. If capacitors are used as the balancing components, the open circuit detection is required for each capacitor and thus comprehensive detection of an open circuit is difficult to curry out. Therefore, the open circuit detection circuit using the balance coils 56 as in this embodiment is especially effective and a low-cost and safe configuration can be provided.

The arrangement of the power supply board 170 may be modified as following.

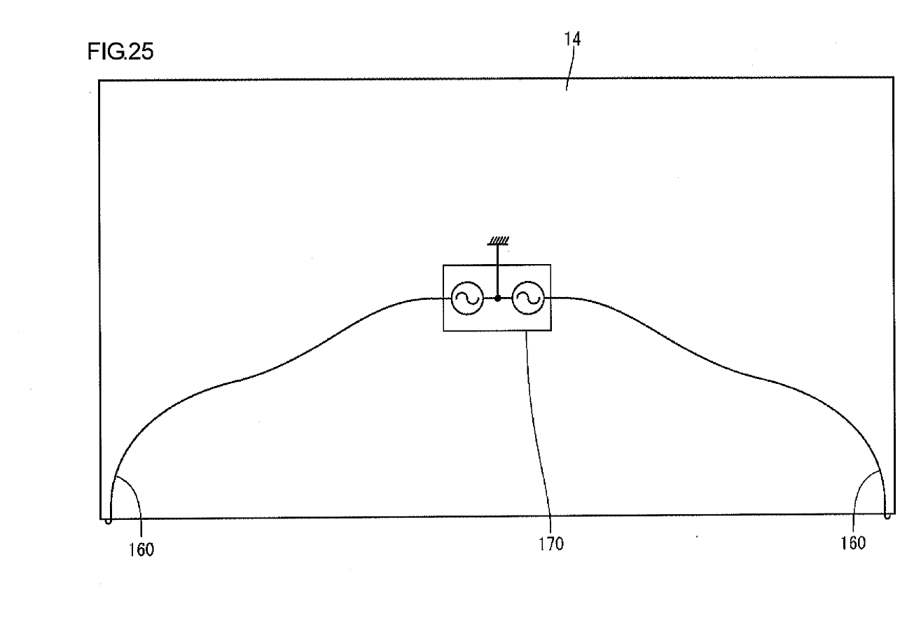

The power supply board 170 in FIG. 25 is arranged in the central area of the rear surface of the chassis 14. As in the above embodiment, only a single power supply line 160 is required to supply power using the balance coils 56. Therefore, a leak current is easily controlled and thus the power supply board 170 can be arranged in the central area of the chassis 14. As a result, the liquid crystal display device 10 using the backlight device 12 can be even thinner and this adds higher values to it.

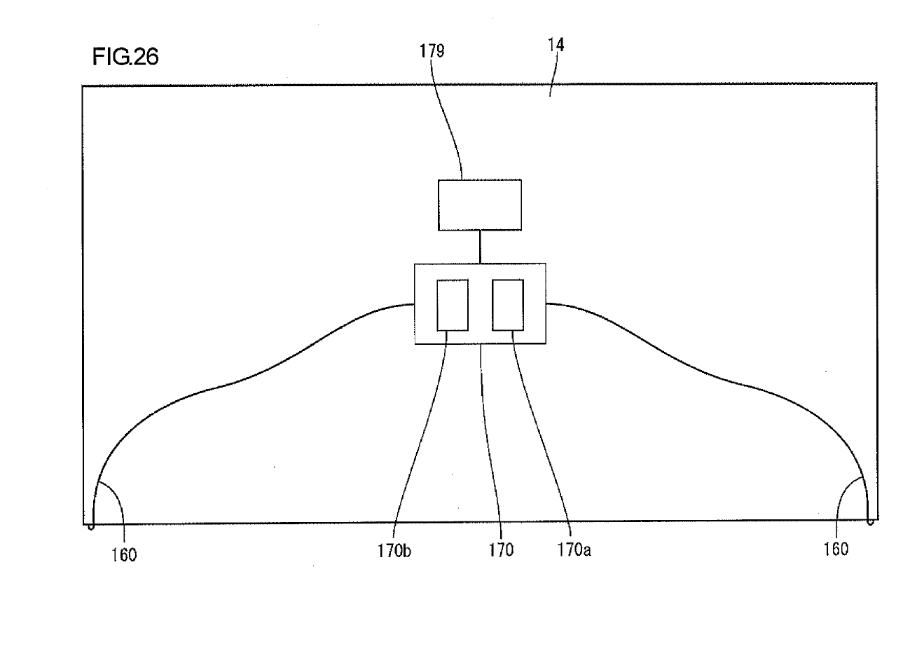

As illustrated in FIG. 26, the power supply board 170 may include a light source driving circuit 170a for driving the light source and a panel driving circuit 170b for driving the liquid crystal panel 11. With this configuration, a primary power is collectively supplied by an AC power source 179. As in the above embodiment, only a single power supply line 160 is required to supply power using the balance coils 56. Therefore, a light source driving circuit 170a for driving the light source and a panel driving circuit 170b for driving the liquid crystal panel 11 can be provided on the same power supply board 170. With this configuration, a primary power is collectively supplied to the power supply board 170 by an AC power source 179.

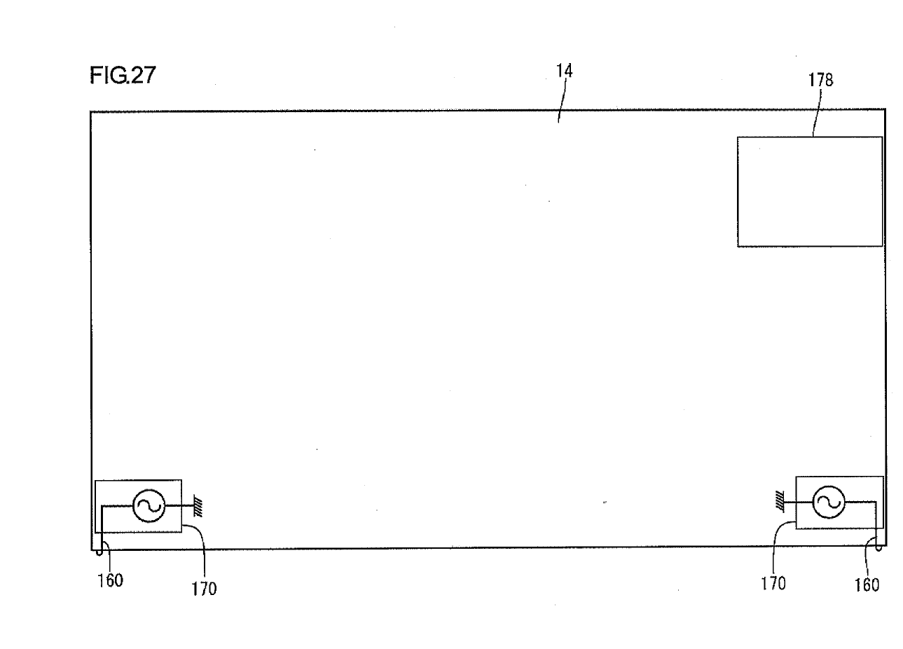

As illustrated in FIG. 27, an external information input and output means 178 such as a disk drive may be arranged in an empty space of the chassis 14 in which the power supply boards 170 are arranged. To supply power using the balance coils 56, only a single power supply line 160 is required and thus the power supply board 170 can be reduced in size. Therefore, the power supply board 170 can be arranged in a part of the chassis along one side (short side) and the external information input and output means 178 such as a disk drive can be arranged in another area. Namely, the space is effectively used.

The display panel 11 of the liquid crystal display device 10 may includes switching components other than TFTs. For example, MIMs (Metal Insulator Metal) or other types of switching components can be used. The display device of the present invention is not limited to the liquid crystal display device and various kinds of display device including lighting devices provided behind display panels can be used.

1. A lighting device for a display device comprising:
a plurality of light sources;
a power source configured to supply driving power to said plurality of light sources;
a plurality of connecting terminals configured to hold said plurality of light sources separately and to function as driving power supply terminals for respective light sources; and
balance coils disposed between said connecting terminals and said power source and configured to make an amount of current of the driving power supplied to respective connecting terminals constant.

2. The lighting device for a display device according to claim 1, wherein:
said connecting terminals are disposed on a single base; and
said balance coils are disposed on the single base.

3. The lighting device for a display device according to claim 1, wherein:
said balance coils are arranged one for each of said connecting terminals; and
each of said balance coils is connected to said power source in parallel.

4. The lighting device for a display device according to claim 1, wherein:
said balance coils and said power source are connected by power supply means; and
a number of said power supply means is smaller than that of the light sources.

5. The lighting device for a display device according to claim 1, wherein said power supply means connecting said balance coils and said power source is configured with a single means.

6. The lighting device for a display device according to claim 4, further comprising,
a chassis configured to house said plurality of light sources, wherein:
said plurality of light sources, said connecting terminals and said balance coils are arranged inside said chassis;
said power source is arranged outside said chassis; and
said power supply means is routed from the balance coils arranged inside the chassis to said power source arranged outside the chassis.

7. The lighting device for a display device according to claim 6, wherein:
said connecting terminals are disposed on a single base; and
said balance coils are disposed on the single base; and
an insulation member is provided between said chassis and said single base.

8. The lighting device for a display device according to claim 6, wherein:
said connecting terminals are arranged on a single base;
said balance coils are arranged on said single base; and
said chassis has an opening in an area overlapping said single base.

9. The lighting device for a display device according to claim 6, wherein said chassis is made of resin material.

10. The lighting device for a display device according to claim 6, wherein said power source is arranged in a central area of said chassis.

11. The lighting device for a display device according to claim 6, wherein:
said power source is arranged in an area along a part of a side of said chassis; and
an external information input and output means is arranged in an area long another part of said side of said chassis.

12. The lighting device for a display device according to claim 1, wherein:
said plurality of light sources is configured in a linear shape; and
ferrules configured to be electrically connectable with said connecting terminals are attached to ends of said plurality of light sources in the linear shape.

13. The lighting device for a display device according to claim 1, wherein:
said balance coils include primary coils and secondary coils; and
said primary coils are connected to said connecting terminals and said secondary coils are connected with each other in series.

14. The lighting device for a display device according to claim 1, wherein said power source includes an inverter circuit that generates a high-frequency voltage.

15. The lighting device for a display device according to claim 1, further comprising a driving circuit configured to drive a display device to which light is supplied, wherein:
said power source is mounted on a power supply board on which said driving circuit is mounted; and
said power supply board is supplied with primary power collectively.

16. The lighting device for a display device according to claim 1, wherein:
each of said connecting terminals includes an elastic piece capable of elastically holding an end of each of said plurality of light sources; and
said elastic piece includes an elasticity control member configured to control an amount of elastic deformation of said elastic piece.

17. A display device comprising:
a lighting device for a display device according to claim 1; and
a display panel configured to display using light from said lighting device for a display device.

18. The display device according to claim 17, wherein said display panel is a liquid crystal panel using liquid crystal.

19. A television receiver comprising a display device according to claim 17.
